(19) United States
(12) Patent Application Publication
(10) Pub. No.: US 2010/0032629 A1
(43) Pub. Date: Feb. 11, 2010

(54) Adhesive composition containing carbon nanotubes and a copolyamide

(76) Inventors: Benoit Brule, Beaumont Le Roger (FR); Philippe Bussi, Versailles (FR); David Modicom, Tourville La Campagne (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/187,821

(22) Filed: Aug. 7, 2008

(51) Int. Cl. H01B 1/24; C08G 69/26

(52) U.S. Cl. 252/511; 524/606; 524/602; 524/612

(57) ABSTRACT

The present invention relates to a composition containing: (a) carbon nanotubes and (b) at least one copolyamide capable of being obtained from at least two different starting products chosen from: (i) the lactames, (ii) the aminocarboxylic acids and (iii) equimolar quantities of diamines and dicarboxylic acids.

It also relates to the use of this composition as electrically conductive glue, as well as the use of a dispersion of carbon nanotubes, in such a copolyamide, in order to produce an electrically conductive adhesive composition.

The present invention relates to an electrically conductive adhesive composition, containing carbon nanotubes and at least one copolyamide.

It is known that certain copolyamides have adhesive properties making it possible to envisage their use in the production of thermofusible glues having a good resistance to hot water and to dry cleaning, in particular for the heat-sealing of textiles at a low temperature (U.S. Pat. No. 5,459,230; FR 2 228 813; FR 2 228 806; US 2002/0022670) or high temperature (DE 1 594 233).

For certain industrial applications, it can be useful to confer electrical dissipation properties upon these glues in order to avoid the accumulation of electrostatic charges, which are likely to cause safety problems, or even to attract dust.

A solution conventionally used to confer conducting properties upon polymer materials involves dispersing in them conductive charges such as carbon black, in quantities generally ranging from 7 to 30% by weight and, more precisely, in quantities ranging from 7 to 20% by weight for highly structured carbon blacks and from 15 to 30% by weight for less structured carbon blacks.

It has become apparent to the Applicant that the introduction of such quantities of carbon black into certain copolyamides increased the bending modulus of these materials and reduced their adhesive properties.

It is to the Applicant's credit that he has identified another solution making it possible to increase the conductivity of these copolyamides while preserving their adhesive properties, and thus to propose a copolyamide-based composition, which can be used as a conductive glue.

A subject of the present invention is therefore a composition comprising: (a) carbon nanotubes and (b) at least one copolyamide capable of being obtained from at least two different starting products chosen from: (i) the lactames, (ii) the aminocarboxylic acids and (iii) equimolar quantities of diamines and dicarboxylic acids.

A subject of the present invention is also the use of this composition as an electrically conductive glue.

A further subject is the use of a dispersion of carbon nanotubes in a copolyamide in order to produce an electrically conductive adhesive composition.

In the preamble, it is stated that the expression “comprised between” used in the remainder of this description must be understood as including the limits mentioned.

The constituents of the composition used according to the invention will now be described in detail.

Copolyamide

The composition according to the invention comprises, as a first constituent, a copolyamide which can be formed from any monomers, provided that it has adhesive properties, in particular in compression heat-sealing operations.

This copolyamide preferably has a melting temperature comprised between 40 and 150° C., preferably between 70 and 140° C. In particularly advantageous manner, the average numerical molecular mass of this copolyamide can be comprised between 5,000 and 15,000 g/mol.

According to a preferred variant, a relatively fluid copolyamide is chosen. For example, in the particular case of the copolyamide marketed under the trade name Platamid® H106 by ARKEMA, the melt flow index (hereafter, MFI), which expresses this character of fluidity, is at least 10, preferably at least 15 g/10 min and more preferably at least 20 g/10 min, at 130° C. under a load of 2.16 kg.

The polyamide copolymers, also called copolyamides, can be obtained from various starting materials: lactames, aminocarboxylic acids or equimolar quantities of diamines and dicarboxylic acids. The production of a copolyamide requires the choice of at least two different starting products from those mentioned previously. The copolyamide then comprises at least these two units. They may therefore be a lactame and an aminocarboxylic acid having a different number of carbon atoms, or two lactames having different molecular masses, or also a lactame combined with an equimolar quantity of a diamine and a dicarboxylic acid.

The copolyamide used according to the invention can for example be obtained from (i) at least one lactame chosen from lauryllactame and/or caprolactame, preferably a combination of these two lactames, and at least one other polyamide precursor chosen from (ii) the aminocarboxylic acids and (iii) equimolar quantities of diamines and dicarboxylic acids.

The aminocarboxylic acid is advantageously chosen from the α,ω-amino carboxylic acids such as 11-aminoundecanoic acid or 12-aminododecanoic acid.

For its part, the precursor (iii) can in particular be a combination of at least one C₆-C₃₆ aliphatic, cycloaliphatic or aromatic carboxylic diacid, such as adipic acid, azelaic acid, sebacic acid, brassylic acid, n-dodecanedioic acid, terephthalic acid, isophthalic acid or 2,6-naphthalene dicarboxylic acid with at least one C₄-C₂₂ aliphatic, cycloaliphatic, arylaliphatic or aromatic diamine, such as hexamethylene diamine, piperazine, 2-methyl-1,5-diaminopentane, m-xylylene diamine or p-xylylene diamine; it being understood that said carboxylic diacid(s) and diamine(s) are used, when they are present, in equimolar quantities.

The copolyamide according to the invention can advantageously comprise precursors originating from resources obtained from renewable raw materials, i.e. comprising organic carbon of renewable origin determined according to the standard ASTM D6866. Among these monomers obtained from renewable raw materials, there can in particular be mentioned 9-aminononanoic acid, 10-aminodecanoic acid, 12-aminododecanoic acid and 11-aminoundecanoic acid and its derivatives, in particular N-heptyl-11-aminoundecanoic acid, as well as the diamines and diacids made clear in the Application PCT/FR2008/050251. The following in particular are capable of being envisaged:
the diamines chosen from butanediamine (z=4), pentanediamine (z=5), hexanediamine (z=6), heptanediamine (z=7), nonanediamine (z=9), decanediamine (z=10), undecanediamine (z=11), dodecanediamine (z=12), tridecanediamine (z=13), tetradecanediamine (z=14), hexadecanediamine (z=16), octadecanediamine (z=18), octadecenediamine (z=18), eicosanediamine (z=20), docosanediamine (z=22) and the diamines obtained from fatty acids, and
the diacids chosen from succinic acid (w=4), adipic acid (w=6), heptanedioic acid (w=7), azelaic acid (w=9), sebacic acid (w=10), undecanedioic acid (w=11), dodecanedioic acid (w=12), brassylic acid (w=13), tetradecanedioic acid (w=14), hexadecanedioic acid (w=16), octadecanoic acid (w=18), octadecenoic acid (w=18), eicosanedioic acid (w=20), docosanedioic acid (w=22) and the dimers of fatty acids containing 36 carbons.

Examples of copolyamides capable of being utilized within the framework of the present invention are for example the 6/6.6/6.10, 6/6.6/6.12, 6/6.6/6.36 or also 6/6.6/10.10 copolyamides.

It is preferable to use as polyamide precursors a combination of adipic acid and hexamethylene diamine and/or 11-aminoundecanoic acid. It is moreover preferable that the proportion of aromatic diacids does not exceed 10 mol % with respect to the total weight of the copolyamide precursors.

According to a particularly preferred embodiment of the invention, the copolyamide is capable of being obtained from caprolactame, adipic acid, hexamethylene diamine, 11-aminoundecanoic acid and lauryllactame. In this embodiment, it can for example be obtained from 25 to 35% by weight caprolactame, 20 to 40% by weight 11-aminoundecanoic acid, 20 to 30% by weight lauryllactame and 10 to 25% by weight of an equimolar mixture of adipic acid and hexamethylene diamine.

These copolymers can be prepared by polycondensation, according to methods well known to a person skilled in the art. They are moreover commercially available from ARKEMA under the trade name PLATAMID® and in particular PLATAMID® H106.

The copolyamide preferably represents from 100 to 95% by weight, and more preferably from 100 to 96% by weight, with respect to the total weight of the composition according to the invention.

Nanotubes

In the composition according to the invention, the copolyamide is combined with carbon nanotubes (hereafter, CNT).

The nanotubes which can be used according to the invention can be of the single-walled, double-walled or multiple-walled type. The double-walled nanotubes can in particular be prepared as described by FLAHAUT et al. in Chem. Com. (2003), 1442. The multiple-walled nanotubes can for their part be prepared as described in the document WO 03/02456. They are preferred for use in the present invention.

Nanotubes usually have an average diameter ranging from 0.1 to 200 nm, preferably from 0.1 to 100 nm, more preferably from 0.4 to 50 nm and, better, from 1 to 30 nm and advantageously a length of 0.1 to 10 μm. Their length/diameter ratio is preferably greater than 10 and most often greater than 100. Their specific surface is for example comprised between 100 and 300 m²/g and their bulk density can in particular be comprised between 0.05 and 0.5 g/cm³ and more preferably between 0.1 and 0.2 g/cm³. The multi-walled nanotubes can for example comprise 5 to 15 sheets and more preferably 7 to 10 sheets.

An example of raw carbon nanotubes is in particular commercially available from ARKEMA under the trade name Graphistrength® C100.

These nanotubes can be purified and/or treated (for example oxidized) and/or ground and/or functionalized, before their utilization in the process according to the invention.

The grinding of the nanotubes can in particular be carried out when cold or hot and be carried out according to the known techniques implemented in equipment such as ball mills, hammer mills, edge-runner mills, granulating mills, gas-jet mills or any other grinding system capable of reducing the size of the tangled nanotube network. It is preferable for this grinding stage to be carried out according to a gas-jet grinding technique and in particular in an air-jet grinder.

The purification of the raw or ground nanotubes can be carried out by washing using a solution of sulphuric acid, so as to clear them of any residual mineral and metal impurities originating from their preparation process. The weight ratio of the nanotubes to the sulphuric acid can in particular be comprised between 1:2 and 1:3. The purification operation can moreover be carried out at a temperature ranging from 90 to 120° C., for example over a period of 5 to 10 hours. This operation can advantageously be followed by stages of rinsing with water and drying the purified nanotubes.

The oxidation of the nanotubes is advantageously carried out by placing them in contact with a solution of sodium hypochlorite containing 0.5 to 15% by weight NaOCl and preferably 1 to 10% by weight NaOCl, for example in a weight ratio of the nanotubes to the sodium hypochlorite ranging from 1:0.1 to 1:1. The oxidation is advantageously carried out at a temperature below 60° C. and preferably at ambient temperature, for a period ranging from a few minutes to 24 hours. This oxidation operation can advantageously be followed by stages of filtration and/or centrifugation, washing and drying of the oxidized nanotubes.

The functionalization of the nanotubes can be carried out by grafting reactive units such as vinyl monomers to the surface of the nanotubes. The material constituting the nanotubes is used as a radical polymerization initiator after having been subjected to a heat treatment at more than 900° C., in medium which is anhydrous and devoid of oxygen, which is intended to eliminate the oxygen groups from its surface. It is thus possible to polymerize methyl methacrylate or hydroxyethyl methacrylate at the surface of carbon nanotubes.

In the present invention raw, optionally ground nanotubes are preferably used, i.e. nanotubes which are neither oxidized nor purified nor functionalized and have undergone no other chemical treatment.

The nanotubes can represent 0.1 to 5% by weight, preferably 0.5 to 4% by weight, and still more preferably 1 to 3% by weight, with respect to the weight of the composition according to the invention.

According to an advantageous version of the invention, it is possible to use nanotubes made from resources obtained from renewable raw materials, i.e. comprising organic carbon of renewable origin determined according to the standard ASTM D6866. Such a production process has in particular been described by the Applicant in the Patent Application EP 08103248.4.

More preferably, the composition used according to the invention can comprise nanotubes and/or copolyamide precursors originating wholly or partially from resources obtained from renewable raw materials within the meaning of the standard ASTM D6866.

It is preferable for the nanotubes and the copolyamide to be mixed by compounding using conventional devices such as double-screw extruders or co-mixers. In this process, the copolyamide is typically mixed in the molten state with the nanotubes, either in a single stage, or in two stages where the first stage is the production of a masterbatch and the second stage involves mixing or diluting the masterbatch with the copolyamide. A masterbatch formed of copolyamide and nanotubes can comprise 10 to 30% by weight, advantageously 15 to 25% by weight, nanotubes.

As a variant, the nanotubes can be dispersed by any appropriate means in the copolyamide which is in solution in a solvent. In this case, the dispersion can be improved, according to an advantageous embodiment of the present invention, by the use of dispersion systems, such as ultrasound or rotor-stator systems, or specific dispersing agents.

A rotor-stator system is in particular marketed by SILVERSON under the trade name Silverson® L4RT. Another type of rotor-stator system is marketed by IKA-WERKE under the trade name Ultra-Turrax®.

Other rotor-stator systems are also constituted by colloid mills, deflocculating turbines and mixers with high rotor-stator type shearing, such as the equipment marketed by IKA-WERKE or by ADMIX.

The dispersing agents can be in particular chosen from the plasticizers which can themselves be chosen from the group constituted by:

alkylesters of phosphates or hydroxybenzoic acid (the preferably linear alkyl group of which contains 1 to 20 carbon atoms),

phthalates, in particular dialkyl or alkyl-aryl, in particular alkylbenzyl, the alkyl groups, linear or branched, independently containing 1 to 12 carbon atoms,

adipates, in particular dialkyl,

sulphonamides, in particular aryl sulphonamides the aryl group of which is optionally substituted by at least one alkyl group containing 1 to 6 carbon atoms, such as the benzene sulphonamides and the toluene sulphonamides, which can be N-substitued or N,N-disubstitued by at least one alkyl group, preferably linear, containing 1 to 20 carbon atoms, and

their mixtures.

As a variant, the dispersing agent can be a copolymer comprising at least one anionic hydrophilic monomer and at least one monomer including at least one aromatic ring, such as the copolymers described in the document FR-2 766 106, the weight ratio of the dispersing agent to the nanotubes preferably ranging from 0.6:1 to 1.9:1.

In another embodiment, the dispersing agent can be a vinylpyrrolidone homo- or copolymer, the weight ratio of the nanotubes to the dispersing agent in this case preferably ranging from 0.1 to less than 2.

According to another possibility, the mixture of carbon nanotubes and copolyamide can be obtained by dilution of a commercial masterbatch such as the mixture Graphistrength® C M2-20 available from ARKEMA.

The adhesive composition according to the invention can be presented in solid form, in particular in the form of powder, granules, sheets, strands, filaments, threads, etc., or in liquid or semi-liquid form, advantageously in the form of n aqueous dispersion, solution or emulsion.

Apart from the copolyamide and the nanotubes described previously, as well as any plasticizers mentioned above, it can contain at least one adjuvant chosen from the chain limiters, anti-oxygen stabilizers, light stabilizers, colorants, anti-shock agents, antistatic agents, flame retardants, lubricants, and their mixtures.

As indicated previously, the composition according to the invention can be used as electrically conductive glue. It can more particularly be used as thermofusible glue, making it possible to join together identical or different materials chosen in particular from: wood; paper; card; metal; glass; synthetic or natural textiles; leather; sheets of polymer material such as polyesters, polyolefins or polyamides; and self-adhesive cables of deflection coils for cathode ray tubes.

Precisely, the adhesive composition can be presented in the form of monofilaments, multifilaments, fabric, nets or films. This adhesive composition can also be applied to the materials to be joined according to paste coating, powder point coating or double point coating techniques, well known to a person skilled in the art. This composition can thus be applied either to the entire surface of the materials to be joined, or only to distinct areas of the latter, then the laminate obtained can be compressed at a high temperature, typically at 80-150° C., and then cooled down to ambient temperature. Subsequent solvent-drying and/or solvent-evaporation stages are generally not necessary.

The invention will now be illustrated by the following examples, which are given for purposes of illustration only and are not intended to limit the scope of the invention defined by the attached claims.

### EXAMPLES

### Example 1

### Preparation of an Adhesive Composition

Multi-walled carbon nanotubes (Graphistrength® C100 from ARKEMA) were added to a 6/6.6/11/12 copolyamide having a melting temperature of 118° C. and an MFI of 22g/10 min at 130° C. under a load of 2.16 kg (Platamid® H106 from ARKEMA). The nanotubes were added at a rate of 20% by weight to form a masterbatch which was then diluted in a matrix constituted by the same copolyamide, using a DSM double-screw micro-extruder equipped with a sheet and plate die, the extrusion parameters of being as follows: temperature: 225° C.; speed of rotation: 150 rpm; duration of mixing: 30 minutes. Composite films with 3% by weight nanotubes are thus obtained, having a thickness of 500 μm and a width of 30 mm. The latter were cooled down on leaving the die using an air knife.

### Example 2

### Electrical and Adhesive Properties

The resistive and adhesive properties of a film according to Example 1 (hereafter, film A-CNT), by comparison with similar Platamid® H106-based films containing 22% by weight carbon black (Ensaco® 250G from TIMCAL) (hereafter, film A-CB) and with a film of Platamid® H106 free of conductive charges (hereafter, film A).

The surface resistances were measured using a Sefelec M1500P device equipped with electrodes, under the following conditions:

applied voltage: 100 V

charge time before reading: 15 seconds

length of the electrodes: 30 mm

distance between electrodes: 50 mm.

The adhesive properties were measured after application of each of the films tested, on the one hand, to a sheet of PET with a thickness of 350 μm and, on the other hand, between two sheets of PET with a thickness of 170 μm. The corresponding bilayer and trilayer structures were obtained by hot press moulding of these laminates under the conditions below:

temperature of the heating plates: 150° C.

hold time between plates: 5 min

hold pressure: low.

These structures were subjected to a peeling test on a DY30 dynamometer, according to a method with free geometry, using a pulling speed of 50 mm/min and a 100 N test cell.

The results of these tests are compiled in Table 1 below.

TABLE 1

| | | Film A- | Film A- |
|---|---|---|---|
| | Film A | CB | CNT |
| Resistivity (ohm) | 1 × 10¹² | <1 × 10⁶ | <1 × 10⁶ |
| Adhesion on PET - | 6 | 0 | 1 |
| Bilayer structure | | | |
| (N/15 mm) | | | |
| Adhesion on PET - | 8 | 0 | 2 |
| Trilayer structure | | | |
| (N/15 mm) | | | |

It is clear from this table that the film constituted by the composition according to the invention (film A-CNT) is as conductive as the film A-CB whilst exhibiting better adhesive properties.

### Example 3

### Preparation of an Adhesive Composition

A film analogous to that of Example 1 was produced on a micro-extruder operating at 240° C. (the other extrusion parameters corresponding to Example 1), except that it contained 2% by weight carbon nanotubes.

### Example 4

### Peeling Test

The adhesive properties of the film obtained in Example 3 (hereafter, film B-CNT) were compared to those of a film which was identical but did not contain carbon nanotubes (hereafter, film B) after each of these films was applied between two sheets of PET with a thickness of 175 μm and the resulting laminates were pressed as indicated in Example 2.

The trilayer structures thus obtained were subjected to a peeling test on a DY30 dynamometer, according to a method with free geometry (angle of 90°), using a pulling speed of 50 mm/min and a 100 N test cell. The test was carried out in duplicate.

The average of the maximum peeling forces measured during these tests is:

for film B: 11.5 N/15 mm

for film B-CNT: 9.5 N/15 mm.

The peeling forces observed for the film constituted by the composition according to the invention are therefore similar to those measured for the comparative film. However, film B-CNT is conductive, whilst film B is insulating. In this respect, it was verified that the surface resistance of film B-CNT was less than or equal to 1×10⁶ ohm, whereas that of film B was of the order of 1×10¹² ohm.

These examples thus demonstrate that the carbon nanotubes make it possible to obtain a compromise between adhesive and conduction properties.

1. An electrically conductive adhesive consisting essentially of: (a) a conductive amount of carbon nanotubes and (b) an adhesive amount of at least one copolyamide capable of being obtained from at least two different starting products chosen from: (i) lactams, (ii) aminocarboxylic acids and (iii) equimolar quantities of diamines and dicarboxylic acids.

2. A composition according to claim 1, wherein the copolyamide is capable of being obtained by polycondensation of (i) at least one lactam chosen from lauryllactam and/or caprolactam, preferably a combination of these two lactams, and at least one other polyamide precursor chosen from (ii) the aminocarboxylic acids and (iii) equimolar quantities of diamines and dicarboxylic acids.

3. A composition according to claim 1, wherein said copolyamide has a melting temperature comprised between 40 and 150° C.

4. A composition according to claim 1, wherein the starting product is 11-aminoundecanoic acid or 12-aminododecanoic acid.

5. A composition according to claim 1, the starting product (iii) is a combination of at least one C₆-C₃₆ aliphatic, cycloaliphatic or aromatic carboxylic diacid with at least one C₄-C₂₂ aliphatic, cycloaliphatic, arylaliphatic or aromatic diamine, with the provision that carboxylic diacid(s) and diamine(s) are combined in equimolar quantities.

6. A composition according to claim 5, wherein said starting products (iii) comprises a combination of adipic acid and hexamethylene diamine.

7. A composition according to claim 1, wherein said copolyamide is formed from 11-aminoundecanoic acid.

8. A composition according to claim 1, wherein said copolyamide is capable of being obtained from caprolactam, adipic acid, hexamethylene diamine, 11-aminoundecanoic acid and lauryllactam.

9. (canceled)

10. (canceled)

11. A process for gluing together identical or different materials, comprising:
1—applying to the materials to be joined an adhesive composition according to claim 1
2—compressing the laminate thus obtained at a high temperature, and
3—cooling it down to ambient temperature.

12. A masterbatch comprising: (a) from 15 to 25 wt. % of carbon nanotubes and (b) at least one copolyamide capable of being obtained from at least two different starting products chosen from: (i) lactams, (ii) aminocarboxylic acids, and (iii) equimolar quantities of diamines and dicarboxylic acids.

13. A process for manufacturing the composition of claim 1, comprising
mixing the nanotubes and the copolyamide in the molten state so as to produce a masterbatch comprising from 10 to 30% by weight of nanotubes,
mixing or diluting said masterbatch with the copolyamide so as to obtain an electrically conductive composition comprising from 0.1 to 5% by weight of nanotubes.

14. A composition according to claim 1, wherein the carbon nanotubes are present in the composition a concentration of 0.1 to 5% by weight.

15. A composition according to claim 1, wherein the carbon nanotubes are present in the composition a concentration of 0.5 to 4% by weight.

16. A composition according to claim 1, wherein the carbon nanotubes are present in the composition a concentration of 1 to 3% by weight.

17. A composition according to claim 1, wherein said nanotubes are raw carbon nanotubes which are neither oxidized nor purified nor functionalized and have undergone no other chemical treatment.

18. A process according to claim 11, wherein said nanotubes are raw carbon nanotubes which are neither oxidized nor purified nor functionalized and have undergone no other chemical treatment.

19. A laminate produced according to claim 11.
